(19) United States
(12) Patent Application Publication
(10) Pub. No.: US 2026/0295987 A1
(43) Pub. Date: Oct. 1, 2026

(54) FLEXIBLE WEB-TYPE COMPOSITE MATERIAL AND BAGS MADE FROM SAME

(71) Applicant: STARLINGER & CO GESELLSCHAFT M.B.H., Wien (AT)

(72) Inventors: David GRABENWEGER, Furth an der Triesting (AT); René KOLM, Mauerbach (AT)

(21) Appl. No.: 19/480,149

(22) PCT Filed: Apr. 23, 2024
(86) PCT No.: PCT/EP2024/061003

§ 371 Date: Oct. 30, 2025

(30) Foreign Application Priority Data
May 3, 2023 (EP) 23171429.6

(51) Int. Cl. B32B 37/24; B29C 53/38; B32B 5/02; B32B 5/16; B32B 27/08; B32B 27/32; B32B 37/04; B32B 37/12

(52) U.S. Cl. CPC B32B 37/24; B29C 53/382; B32B 5/022; B32B 5/16; B32B 27/08; B32B 27/32; B32B 37/04; B32B 37/12; B32B 2260/021; B32B 2260/046; B32B 2264/0257; B32B 2307/724; B32B 2323/04; B32B 2323/10; B32B 2439/06

(57) ABSTRACT

A flexible web-shaped composite material (2) comprises a web-shaped substrate (3) containing at least in part a first thermoplastic polymer and a web-shaped nonwoven material (4) containing at least in part a second thermoplastic polymer. The web-shaped substrate (3) and the web-shaped nonwoven material (4) are connected to each other at their facing surfaces (3a, 4a), which form a connection surface, by a plurality of discrete, distributed connection points, wherein the connection points consist of particles (7) containing a third thermoplastic polymer, wherein the particles (7) adhere substantially only to the facing surfaces (3a, 4a) of the substrate (3) and the nonwoven material (4). The discrete, distributed connection points are spaced apart from each other with voids between them. The particles (7) engage positively in cavities in the nonwoven material (4).

The invention relates to a flexible web-shaped composite material, particularly for packaging, and sacks produced therefrom.

The document EP 3 463 805 B1 describes anti-slip, flexible materials and methods for their manufacture and use. In such methods, discrete thermoplastic particles heated to a tacky state are applied to a surface of a thermoplastic flexible carrier, which can be used as a slip-resistant flexible packaging material. Anti-slip flexible packaging bags are also disclosed, with their outer surfaces having roughening projections, as well as methods for their manufacture and use. If such bags lie on top of each other, the roughening projections prevent them from slipping relative to each other, even if the material of the bags is actually not anti-slip because the projections interlock with each other. It is also noted that these projections provide an effective, anti-slip mechanical interlock with a fibrous intervening material such as a commercially available nonwoven, which is placed between two bags, for example. The nonwoven can be lifted off vertically from the rough surface. Furthermore, it is described in this document that the bag can consist of a film and/or a woven fabric and/or a nonwoven fabric. FIG. 12a of EP 3 463 805 B1 shows a tubular web made of a plastic film, in which roughening projections are attached to one surface and a strip of nonwoven is fixed to the opposite surface, either by a fibre-sprayed hot-melt adhesive or by extrusion lamination, by continuously applying narrow strands of an extruded polyolefin polymer in order to encapsulate the fibres of the nonwoven and fix them to the film, and the sandwich arrangement made of film/melt/nonwoven is pressed between a pair of metal rollers.

A film-nonwoven composite material produced in this manner involves the disadvantage that the mechanical properties of the nonwoven are changed by the hot-melt adhesive or the extruded polyolefin polymer in that the hot-melt adhesive or the extruded polyolefin polymer encases the fibres of the nonwoven and is then pressed against the film. As a result, the hot-melt adhesive or the extruded polyolefin polymer penetrates the nonwoven as far as to its surface facing away from the film, whereby it becomes stiff and the mechanical interlock with the rough surface of the film is impaired. The types of fixing the nonwoven to the film, as described, also involve a high material consumption of hot-melt adhesive or polyolefin polymer, which is not necessary for the desired mechanical interlock function of the nonwoven. Moreover, the use of hot melt is disadvantageous since hot-melt adhesives are expensive and hamper the recycling of items produced from the film-nonwoven composite material.

Document US 2015/0036952 A1 describes the production of a packaging bag with an anti-slip coating. In this process, an easily extrudable olefinic elastomer is applied from an extrusion head to a woven polypropylene packaging bag and immediately flattened with rollers in several spaced apart strips with the aim of increasing the coefficient of friction of the surface of the bag.

Document US 2019/02913337 A1 discloses an anti-slip, heat-sealable plastic packaging bag as well as a method and device for its manufacture. The bag is made from a flexible plastic material to the surface of which a plurality of separate anti-slip protrusions made from a thermoplastic polymer are applied. The material of the anti-slip protrusions should be different from the material of the bag.

A method of preparing a thermoplastic film web for further processing into sacks is known from DE 40 33 499 A1, the sacks having perforated areas which are covered with strips of nonwoven. The strips of nonwoven are attached to the film web using a bonding agent, the film web, the strip of nonwoven and the bonding agent being made of the same thermoplastic material. This method solves the problem that plastic sacks coated with adhesives cannot be recycled anymore or can be recycled only for low-quality applications. During the manufacture of the sacks, the melted bonding agent is applied along the marginal areas of the strip of nonwoven between the strip of nonwoven and the film web, and a bonding pressure is exerted on the strip of nonwoven, the bonding agent and the film web so that the thermoplastic material of the bonding agent penetrates at least partially into the strip of nonwoven and connects the strip of nonwoven with the film web, with the thermoplastic material hardening. The method described in DE 40 33 499 A1 involves the above-described disadvantage that the partial or complete penetration of plastic into the nonwoven impairs the mechanical interlock thereof with rough surfaces of adjacent sacks. In addition, the attachment of the strip of nonwoven occurs only at its edges so that the nonwoven is freely movable between its edges due to its elastic properties, for which reason it is not suitable for preventing sacks lying on top of each other from slipping. This problem is not addressed in DE 40 33 499A1, because, in the disclosed sacks, the strips of nonwoven serve only to cover perforations in the sack body produced from the film web. For this reason alone, it would not be possible to attach the strip of nonwoven over the entire surface of the film web by applying the melted bonding agent and subsequently exerting a bonding pressure, as the perforations in the film web would thereby be closed.

A method of producing a sack is known from the document WO 2011/018318A1, the sack containing a plastic nonwoven material. The method comprises providing an at least two-layer flat web material with a first layer made of a plastic nonwoven material and a second layer made of a plastic coating, forming a tube from the flat web material by placing the side areas of the flat web material on top of each other and interconnecting them to form an overlap, with the plastic coating being oriented outwards and the plastic nonwoven material layer being oriented inwards after the tube has been formed, separating the tube into tube pieces and integrally forming a bottom on at least one end of a tube piece. Before the tube is separated into tube pieces, the at least two-layer flat web material or the tube produced therefrom is perforated. This is necessary because the plastic nonwoven material layer is actually permeable to air, which is important when filling the sacks so that the air can escape from the interior of the sack, but the plastic coating prevents the air from escaping. However, the disadvantage associated with perforating the flat web material comprising the plastic nonwoven material layer and the plastic coating is that the plastic nonwoven material layer is thus also perforated. With its many fibres, a nonwoven layer forms a labyrinth that actually allows air to pass through, but retains the usually granular or powdery filling material contained in the sack and thereby prevents the filling material from leaking out of the sack. If the nonwoven layer is now perforated, the perforation forms a straight passage through the entire flat web material so that the nonwoven layer can no longer prevent the filling material from passing through the flat web material forming the sack wall.

Document DE 697 30 689 T2 addresses the problem of treating a fragile carrier tape material with an active component, such as a powdered adsorbent or absorbent material. An example of this is a non-woven material coated with agents that have water-absorbing or odor-adsorbing properties, as is the case with a diaper or sanitary product. To solve this problem, a composite web is proposed that comprises a carrier web and a powder mixture deposited on the surface of the carrier web, wherein the powder mixture comprises particles of a thermoplastic binder and particles of an active agent, wherein the particles of the thermoplastic binder are fused to the particles of the active agent and to the carrier web. The composite web may have a second carrier web on top of the particles of the powder mixture, so that a sandwich effect is achieved, whereby the active agent is incorporated between two web surfaces. The thermoplastic binder is fused with the active particles and the carrier web. The layer of fused active agent and thermoplastic binder seals the cavities of the carrier web material, which is important and desirable in the case of water or odor-adsorbing products. In the case of composite materials that have a nonwoven fabric, however, this layer changes the properties of the nonwoven fabric. In particular, the air permeability of the nonwoven fabric is lost through its labyrinth passages. The layer of fused active agent and thermoplastic binder is a material that is the core of the products that can be manufactured according to DE 697 30 689T2 . For a composite material for packaging, such a material is not only superfluous, but also prevents the composite material from being recycled.

WO 2022/012887 A1 relates to an aerogel-containing insulation layer in which a mixture of a powdery binder and aerogel particles is introduced between two substrates made of water-jet nonwovens. The binder is activated by heating, first to bind the aerogel particles to the binder, and then by applying additional pressure to adhere and fix the aerogel-binder mixture to the substrates. The disadvantages listed above for DE 697 30 689 T2 apply equally to the subject matter of WO 2022/012887A1.

It is the object of the present invention to propose a flexible web-shaped composite material which overcomes or at least mitigates the above-mentioned disadvantages of the prior art and leaves the cavities of the fleece material largely intact. In one aspect of the invention, the flexible web-shaped composite material according to the invention serves for the manufacture of sacks.

The invention solves the problem by providing a flexible web-shaped composite material having the features of claim 1. Advantageous embodiments of the invention are set forth in dependent claims, in the specification and in the drawings.

The flexible web-shaped composite material, particularly for packaging, comprises a web-shaped substrate containing, at least partially, a first thermoplastic polymer, and a web-shaped nonwoven material containing, at least partially, a second thermoplastic polymer. The web-shaped substrate and the web-shaped nonwoven material are interconnected on their mutually facing surfaces, which form a connecting surface, by a plurality of discrete, distributed connecting points, the connecting points consisting of particles containing a third thermoplastic polymer, the particles adhering essentially only to the mutually facing surfaces of the substrate and the nonwoven material.

Due to this configuration of the composite material the substrate and the nonwoven material are interconnected by a plurality of discrete connecting points made of the particles containing the third thermoplastic polymer, the connecting points extending essentially over the entire connecting surface between the substrate and the nonwoven material, while being distributed as evenly as possible, so that the overall effect of a “full-surface” connection with homogeneous connecting properties is created, even though there are a large number of point-like connection points. In contrast to the aerial bonding of a substrate and a nonwoven, as known from the prior art, the cavities in the nonwoven material remain largely intact, according to the invention, so that they will be preserved both for a positive connection with a material that has been rendered slip-resistant by the application of plastic particles and for the retention of powdery or granular material through the labyrinth passages formed by the cavities in the nonwoven. The bonding strength provided by the particles is surprisingly high because the particles adhering to the substrate penetrate into the cavities of the nonwoven fabric during the manufacture of the composite material and become entangled therein, resulting in the aforementioned form-fit.

As mentioned, the composite material according to the invention has a plurality of discrete, distributed connection points for connecting the substrate to the nonwoven material, wherein the connection points consist of particles containing a third thermoplastic polymer. The invention further provides that the discrete, distributed connection points are spaced apart from each other with empty spaces between them.

Another advantage of the invention is that the material consumption of the bonding agent, i.e., the particles, is significantly lower than when bonding a substrate to a nonwoven by areal layers, as proposed in the prior art. Another positive effect of the invention is the possibility of jointly recycling substrate and nonwoven, i.e., the whole composite material.

A method of producing the flexible web-shaped composite material according to the invention comprises
providing a web-shaped substrate containing, at least partially, a first thermoplastic polymer,
providing a web-shaped nonwoven material containing, at least partially, a second thermoplastic polymer,
applying discrete particles containing a third thermoplastic polymer to the web-shaped substrate or to the web-shaped nonwoven material, by
providing a release surface, providing and arranging a plurality of the discrete particles on the release surface, the release surface having a temperature which is above a softening temperature of the third thermoplastic polymer, heating the particles arranged on the release surface above the softening temperature of the third thermoplastic polymer, contacting a surface of the substrate or the nonwoven material with the release surface and the softened particles arranged thereon so that the particles adhere to the surface of the substrate or the nonwoven material, subsequently removing the surface of the substrate or the nonwoven material with the particles adhering thereto from the release surface, and optionally cooling the particles adhering to the surface of the substrate or the nonwoven material to below the softening temperature of the third thermoplastic polymer,
bringing the substrate and the nonwoven material together, the surface of the substrate or the nonwoven material with the particles adhering thereto facing a surface of the nonwoven material or the substrate,
pressing the substrate and the nonwoven material together, whereby the particles interconnect the mutually facing surfaces of the substrate and the nonwoven material, optionally heating the particles adhering to the surface of the substrate or the nonwoven material above the softening temperature of the third thermoplastic polymer before the substrate and the nonwoven material are pressed together,
and optionally cooling the composite material thus produced from the substrate and the nonwoven material.

In a further development of the method, after the substrate and the nonwoven material have been pressed together, discrete particles containing a fourth thermoplastic polymer are applied to the surface of the substrate which is opposite to the nonwoven material, by providing a release surface, providing and arranging a plurality of the discrete particles on the release surface, the release surface having a temperature which is above a softening temperature of the fourth thermoplastic polymer, heating the particles arranged on the release surface above the softening temperature of the fourth thermoplastic polymer, contacting the surface of the substrate which is opposite to the nonwoven material with the release surface and the softened particles arranged thereon so that the particles adhere to the surface of the substrate, and subsequently removing the surface of the substrate with the particles adhering thereto from the release surface, and optionally cooling the particles adhering to the surface of the substrate to below the softening temperature of the fourth thermoplastic polymer. In this text, “cooling” is generally understood to mean active cooling using a cooling device or passive cooling by allowing cooling in the ambient air, for example.

The flexible web-shaped composite material in accordance with the invention thus fulfills all requirements for being processed into sacks which are characterized by high slip resistance when being stacked on top of each other in that the particles applied to a surface of the substrate forming an exterior surface of the sack positively engage the cavities in the nonwoven material of the composite material which, in case of the sack, is arranged on an exterior surface that is opposite to the exterior surface of the sack with the particles. Since the nonwoven material is connected to the substrate over the entire connecting surface by a plurality of connecting points, it does not even become detached when shear forces occur when a stack of sacks lying on top of each other is tilted, with one side with nonwoven of one sack in each case facing a side with particles on the substrate of an adjacent bag. This means that high tilt angles, typically of 35° and more, are possible without the sacks slipping, but the stack of sacks will rather topple first. Stretch films, shrink films or hoods or other means for securing loads can hence be omitted for stacked sacks.

If the substrate or the composite made of the substrate and the nonwoven material is turned over before the particles containing the fourth thermoplastic polymer are applied to the surface of the substrate which is opposite to the nonwoven material and this surface of the substrate faces the release surface, which also serves for the application of the particles containing a third thermoplastic polymer, a device on which the web-shaped composite material is produced can be simplified significantly since a single release surface is used for the application of the particles on both sides of the composite material.

The web-shaped substrate can be tubular for the manufacture of sacks, with the tubular substrate optionally being provided with side folds depending on the type of sacks to be produced from the composite material.

In a preferred embodiment of the invention, the substrate comprises at least one layer made of a plastic tape fabric, preferably made of PP, HDPE or PET. The plastic tape fabric can have a coating, which optionally is printed, or a plastic film which has been laminated on and serves, for example, as a carrier for printing or as a barrier layer, e.g., as a moisture barrier layer.

In an alternative embodiment of the invention, the substrate is a single-or multi-layer, optionally printed plastic film, preferably made of PP, LLDPE, LDPE, HDPE or PET.

For certain applications, the composite material according to the invention must be permeable to air, for example, if valve sacks are produced from the composite material, the valve sacks being filled with a powdery or granular filling material by means of an air stream, wherein the air must be able to escape from the sack. For such applications, it is envisaged that the substrate is perforated before it is brought together with the nonwoven material. In this case, it is crucial that only the substrate, but not the nonwoven material as well, is perforated, because otherwise the nonwoven material would lose its retention function for the filling material, for instance, very fine-grained/finely powdered cement.

The nonwoven material is preferably a spunbonded nonwoven or a carded nonwoven or a spunlace material or a meltblown material or a spunbonded material or a composite material made of the materials mentioned.

It has proven useful if the first and/or the second thermoplastic polymer is/are selected from: PET, PP, PE, or a co-or terpolymer containing two or, respectively, three of the following monomers: ethylene, propylene, vinyl acetate, alkyl acrylate, maleic anhydride, alpha olefin. The first and second thermoplastic polymers can thus be selected from the same material or from different materials.

The third and optionally the fourth thermoplastic polymer is/are preferably selected from: PET, PP, PE, or a co-or terpolymer containing two or, respectively, three of the following monomers: ethylene, propylene, vinyl acetate, alkyl acrylate, maleic anhydride, alpha olefin. The third and fourth thermoplastic polymers can thus be selected from the same material or from different materials.

In a preferred embodiment of the invention, the particles containing the third thermoplastic polymer have an average particle size of less than or equal to 1000 μm.

In order for the particles forming the discrete connection points between the substrate and the nonwoven material to provide satisfactory bonding strength, it is important that the particles are not too small, on the one hand, so that they have a sufficiently large surface area for fusion with fibers of the nonwoven material and, on the other hand, so that they can form a positive connection with the cavities of the nonwoven material. For these reasons, the invention preferably provides that the particles containing the third thermoplastic polymer have a particle size greater than or equal to 100 μm. It has been shown that excellent results in terms of adhesive force and low material consumption can be achieved when the particles containing the third thermoplastic polymer have a particle size between 100 μm and 1000 μm, in a size distribution whose peak value is at least 300 μm. For largely homogeneous bonding properties, particle sizes that are as uniform as possible, in particular with size differences of less than a factor of 3, are particularly preferred. The particles containing the third thermoplastic polymer can be selected by sieving with sieves of defined mesh width, which ensures good uniform particle sizes.

In a further preferred embodiment of the invention, the particles containing the fourth thermoplastic polymer have an average particle size of between 80 and 800 μm, preferably of between 100 and 500 μm, with particle sizes as uniform as possible, in particular with size differences of less than a factor of 3, being particularly preferred for mostly homogeneous connection and slip resistance properties. The particles containing the fourth thermoplastic polymer are selected by screening with screens of a defined mesh size, which ensures good uniform particle sizes.

According to the invention, it is preferred if the particles containing the third thermoplastic polymer having a basis weight of between 1 g and 20 g per m², preferably of between 3 g and 5 g per m², are applied to the substrate and/or the nonwoven material. These basis weights are far below the basis weights of extrusion connections, but still ensure sufficient connection strength, wherein the connection strength can be adjusted by selecting an appropriate basis weight in such a way that the nonwoven material will not become detached from the substrate due to the action of shear forces, but can be pulled off from the substrate by applying force perpendicularly to the connecting surface, manually, for example. If the basis weight of the particles is in the specified range, this also ensures that the cavities of the nonwoven material are not clogged.

It can be envisaged that the particles are adjusted to a temperature which is above their softening temperature but below their melting temperature when they are being connected to the substrate or the nonwoven material. As a result, the particles are embedded in the substrate or the nonwoven material, while the nonwoven material or, respectively, the fibres thereof remain essentially without damage, but good adhesive properties are still produced between the substrate and the nonwoven material (through positive connection). With this procedure, the particles do not form any extensive undefined areas that change the mechanical properties of the substrate or the nonwoven material, as is the case when plastic extrudate or hot melt is introduced over the entire surface. It should be mentioned that it has turned out to be convenient if the particles on the release surface are heated to a higher temperature, which can also be above the melting temperature of the particles, than when the substrate and the nonwoven are connected by means of the particles.

In a further embodiment of the method for producing the composite material according to the invention, in which the web-shaped substrate is provided as a flat web, the web-shaped composite material is formed from the substrate and the nonwoven material into a tube by placing the side areas of the flat, web-shaped composite material on top of each other and interconnecting them to form an overlap, with the nonwoven material forming an inner layer of the tube. Such a tubular composite material can be formed into sacks in which the nonwoven material forms an inner layer which prevents the filling material, such as a fine-grained/finely powdered cement material, from leaking out towards the outside by separating the tube into tube pieces and forming a bottom on at least one end of the tube pieces. This is advantageous especially if the substrate has been perforated before being connected to the nonwoven material.

The invention is explained in further detail below with reference to the drawings using non-limiting exemplary embodiments.

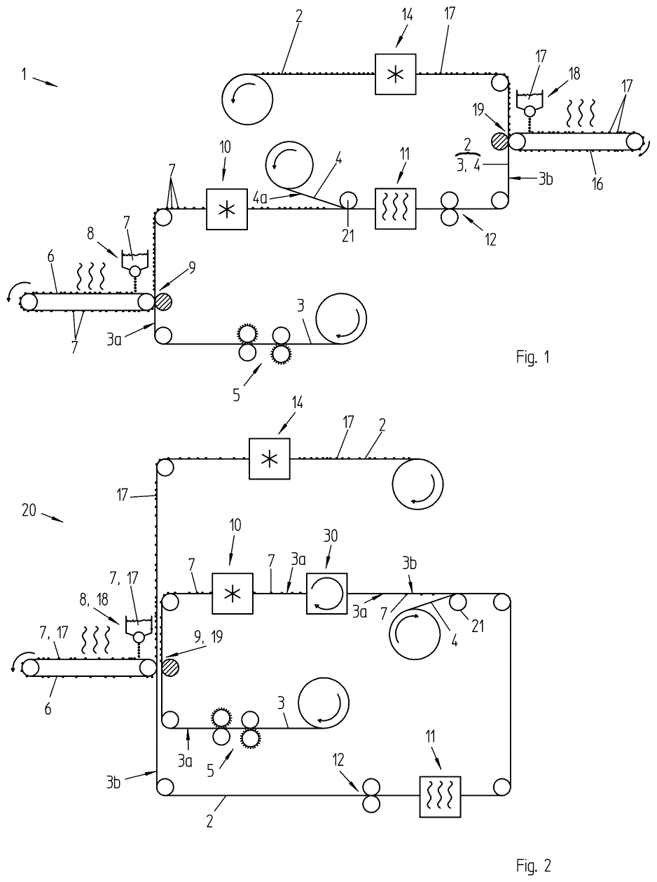

FIG. 1 schematically shows a first embodiment of a device for producing a flexible web-shaped composite material according to the invention.

FIG. 2 schematically shows a second embodiment of a device for producing a flexible web-shaped composite material according to the invention.

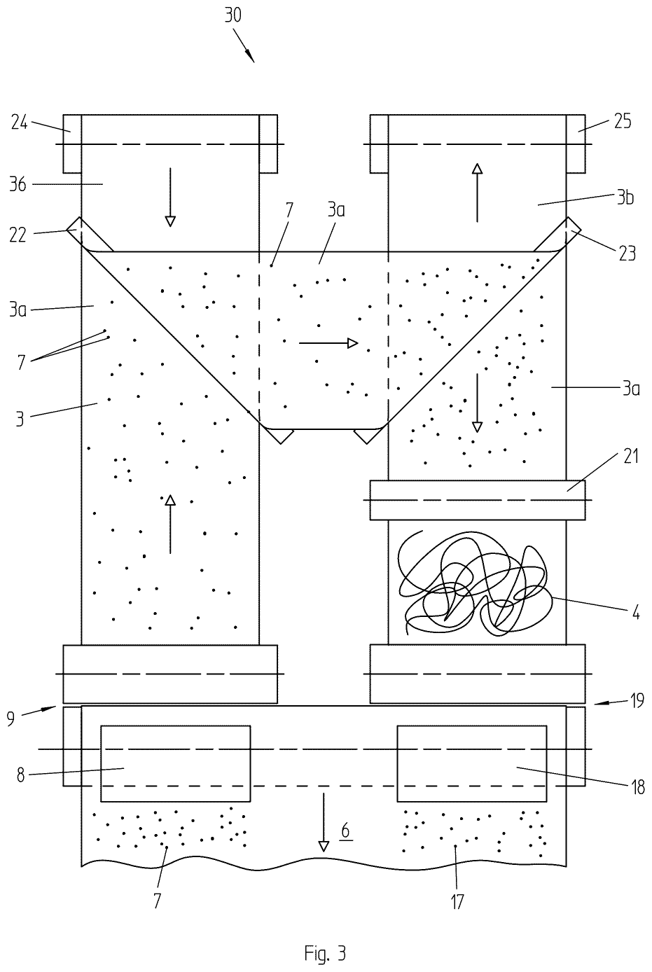

FIG. 3 shows a turnover device of the device of FIG. 2.

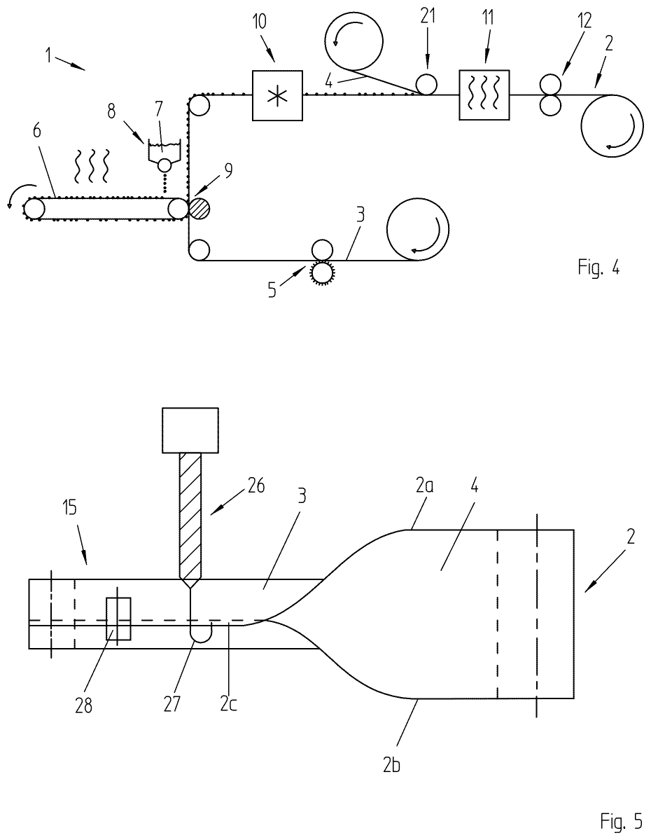

FIG. 4 schematically shows a simplified embodiment of the device shown in FIG. 1 for producing a flexible web-shaped composite material.

FIG. 5 shows the manufacture of a tube from a flat web-shaped composite material according to the invention.

A first embodiment of the invention will now be explained based on the schematic illustration of FIG. 1. FIG. 1 shows a device 1 for producing the flexible web-shaped composite material 2 according to the invention. This device 1 is provided with a web-shaped substrate 3, which at least partially contains a first thermoplastic polymer, wound on a roll. The web-shaped substrate 3 can be a flat material or a tubular material, optionally with side folds. Furthermore, the device 1 is provided with a web-shaped nonwoven material 4, which at least partially contains a second thermoplastic polymer, wound on a roll. When the device 1 is in operation, the web-shaped substrate 3 is unwound from its roll using feed means (not shown), such as driven pairs of rollers, is pulled through a perforation device 5, where it is perforated, and is supplied to a release surface 6. The release surface is designed as a heated continuous conveyor belt revolving on rolls, which is preferably equipped with a surface made of polytetrafluoroethylene (PTFE), known under the brand name “Teflon”, or a material with properties similar to that of PTFE. PTFE has high chemical and thermal resistance, a low coefficient of friction and is anti-adhesive. Discrete particles 7, which contain a third thermoplastic polymer, are applied in large numbers from a container 8 to the release surface 6 in a distribution that is as uniform as possible, using a spreading roller, for example. The heated release surface 6 has a temperature which is above a softening temperature of the third thermoplastic polymer. The particles 7 heat up on the release surface beyond the softening temperature of the third thermoplastic polymer and, in the softened state, adhere sufficiently to the release surface 6 so that they will not fall from the release surface 6 even when they are being transported on the revolving release surface 6. The substrate 3 and the release surface 6 pass through a pair of rollers 9 so that the particles 7 on the release surface 6 face a surface 3a of the substrate 3. The pair of rollers 9 presses the particles 7 against the surface 3a of the substrate 3, whereby the softened particles 7 adhere to the surface 3a of the substrate 3. Subsequently, the surface 3a of the substrate 3 with the particles 7 transferred thereon moves away from the release surface 6, which is thus ready for another application of particles 7. The surface 3a of the substrate 3 is now cooled until the particles 7 have a temperature below the softening temperature of the third polymer. In this exemplary embodiment, cooling occurs actively using a cooling device 10. However, depending on the ambient temperature, the transport speed and the transport length of the substrate 3, passive cooling, e.g., by ambient air, can also be provided, wherein the particles 7 are allowed to cool on the substrate 3. If the substrate 3 with the particles 7 adhering thereto is processed further directly, cooling below the softening temperature can be omitted.

In the following step, the web-shaped nonwoven material 4 is supplied by being unwound from its roll using feed means (not shown), such as driven rollers, and the nonwoven material 4 is brought together with the substrate 3 via a roll 21, the surface 3a of the substrate 3 with the particles 7 adhering thereto facing a surface 4a of the nonwoven material 4. The superimposed layers of the substrate 3 and the nonwoven material 4 are now heated by means of a heating device 11 above the softening temperature of the third thermoplastic polymer of the particles 7 adhering to the surface 3a of the substrate 3, followed by pressing the substrate 3 and the nonwoven material 4 together by means of a pair of rollers 12, whereby the softened particles 7 interconnect the mutually facing surfaces 3a, 4a of the substrate 3 and the nonwoven material 4. The flexible web-shaped composite material 2 produced in this manner is finally cooled either actively using a cooling device 14 or passively by allowing it to cool in the ambient air, while being transported through the device 1, and can be wound onto a roll for further processing.

An embodiment of the device 1 for producing the flexible web-shaped composite material 2, which comprises the previously described parts and in which the composite material 2 is wound onto a roll for further processing, is schematically illustrated in FIG. 4.

The main advantage of the device 1 and the method performed thereon is that the substrate 3 and the nonwoven material 4 are interconnected by a plurality of discrete connecting points made of the particles 7 containing the third thermoplastic polymer, the connecting points extending essentially over the entire connecting surface between the substrate 3 and the nonwoven material 4, while being distributed as evenly as possible, so that the overall effect of a “full-surface” connection with homogeneous connecting properties is created. The cavities in the nonwoven material 4 thereby remain largely intact.

In the embodiment of the device 1 as illustrated in FIG. 1 and FIG. 4, the substrate 3 is first supplied and is brought together with and connected to the nonwoven material 4 after the particles 7 have been applied. However, it should be mentioned that the device 1 is also suitable for initially supplying the nonwoven material 4 and bringing it together with the substrate 3 after the particles 7 have been applied to the nonwoven material 4 so that their surfaces 3a, 4a are interconnected by a plurality of connecting points consisting of the particles 7.

In the embodiment of the device 1 for producing the flexible web-shaped composite material 2, as illustrated in FIG. 1, the composite material is treated further immediately after its manufacture in that discrete particles 17, which contain a fourth thermoplastic polymer, are applied after the substrate 3 and the nonwoven material 4 have been pressed together by the pair of rollers 12 on the surface 3b of the substrate 3 which is opposite to the nonwoven material 4, i.e., facing away therefrom. The application of the particles 17 is done by applying the particles 17 in large numbers from a container 18 to the heated release surface 16 in a distribution that is as uniform as possible, using a spreading roller, for example. The heated release surface 16 has a temperature which is above a softening temperature of the fourth thermoplastic polymer. The particles 17 heat up on the release surface 16 beyond the softening temperature of the fourth thermoplastic polymer and, in the softened state, adhere sufficiently to the release surface 16 so that they will not fall from the release surface 16 even when they are being transported on the revolving release surface 16. The release surface 16 is designed as a heated continuous conveyor belt revolving on rolls, which is preferably equipped with a surface made of PTFE or a material with properties similar to that of PTFE. The composite material 2 and the release surface 16 pass through a pair of rollers 19 so that the particles 17 on the release surface 16 face the surface 3b of the substrate 3. The pair of rollers 19 presses the particles 17 against the surface 3b of the substrate 3 of the composite material 2, whereby the softened particles 17 adhere to the surface 3b of the substrate 3. Subsequently, the surface 3b of the substrate 3 of the composite material 2 with the particles 17 transferred thereon moves away from the release surface 16, which is thus ready for another application of particles 17. The composite material 2 is now cooled actively using a cooling device 14 or passively by allowing it to cool, e.g., in the ambient air, until the particles 17 have a temperature below the softening temperature of the fourth polymer. Subsequently, the web-shaped flexible composite material treated in this way is wound onto a roll for further use, for example, for the manufacture of sacks.

Examples of preferred materials for the first, second, third and fourth thermoplastic polymers are indicated in the text hereinabove.

FIG. 2 schematically shows a further embodiment of a device 20 for producing a flexible web-shaped composite material 2, which performs essentially the same process steps as the device 1 of FIG. 1. Identical or similar device parts as in the embodiment of FIG. 1 are provided in FIG. 2 with the same reference numerals, and, for their explanation, reference is made to the description of the device of FIG. 1. The essential difference between the two devices 1, 20 is that, in the device 20 of FIG. 2, only one release surface 6 is used by means of which both surfaces 3a, 3b of the substrate 3 are successively provided with particles 7, 17. For this purpose, the substrate 3 is turned over in a turnover device 30 after the particles 7 have been applied to its first surface 3a. Subsequently, the nonwoven material 4 is brought together with the first surface 3a of the substrate, which has been provided with the particles 7. By applying heat and pressure in the heating device 11 and the pair of rollers 12, the substrate 3 and the nonwoven material 4 are interconnected on their mutually facing surfaces by a plurality of connecting points, as has been described in detail above with reference to FIG. 1. Afterwards, the composite material 2 produced in this manner is again supplied to the release surface 6, namely in such a way that the surface 3b of the substrate 3 which is opposite to the nonwoven material 4, i.e., facing away therefrom, faces the release surface 6. Discrete particles 17 are applied to this surface 3b of the substrate 3 which is opposite to the nonwoven material 4, and subsequently they are cooled in the cooling device 14. The composite material 2 treated in this way is then wound into a roll.

FIG. 3 shows a top view of an embodiment of a turnover device 30, as it can be employed in the device 20 of FIG. 2. For ease of comprehension of the drawing, some device parts that are not necessary for the explanation have been omitted. What can be seen in the illustration of FIG. 3 is the substrate 3 that has been loaded with the particles 7 containing the third thermoplastic polymer already on the pair of rollers 9, with the particles 7 being applied from the container 8 to the release surface 6. The substrate 3 provided with the particles 7 is turned over by 180° on a first deflection roller 24, is then supplied to a first stationary deflection rod 22, where it is deflected by 90°, and is afterwards supplied to a second stationary deflection rod 23, where it is again deflected by 90°. Afterwards, the substrate 3 is turned over again by 180° around a second deflection roller 25 and is thereby conducted in the direction of the heated release surface 6. Before the substrate 3 comes into contact with the release surface 6, it is brought together with the nonwoven material 4 on the roll 21, as has been described above. Subsequently, the substrate 3 is loaded with the particles 17 containing the fourth thermoplastic polymer on the pair of rollers 19, the particles 17 being applied from the container 18 to the release surface 6.

FIG. 5 schematically shows the formation of a tube 15 from the composite material 2, which is designed as a flat material. For this purpose, the side areas 2a, 2b of the flat, web-shaped composite material 2 are placed on top of each other and interconnected by deflection means (not shown) to form an overlap 2c so that the nonwoven material 4 forms an inner layer of the tube 15. The connection of the side areas 2a, 2b of the flat, web-shaped composite material 2 is achieved by introducing a plastic extrudate into the overlap 2c by means of an extruder 26 and an extrusion nozzle 27 and subsequently passing the overlap 2c through a pair of rollers 28, thereby pressing it together. Sacks can subsequently be formed from the tube 15 by separating the tube 15 into tube pieces and forming a bottom on at least one end of the tube pieces. However, if it has a tubular substrate 3, the composite material 2 can also be separated into tube pieces and a bottom can be formed on at least one end of the tube pieces. As a result, cross-bottom sacks, valve sacks, bags or form-fill-and-seal sacks can be produced, the shapes of which are well known to those skilled in the art. The composite material 2 used is preferably a material whose substrate 3 has been perforated before being connected to the nonwoven material 4.

1. A flexible web-shaped composite material (2), particularly for packaging, comprising a web-shaped substrate (3) containing, at least partially, a first thermoplastic polymer, and a web-shaped nonwoven material (4) containing, at least partially, a second thermoplastic polymer,
wherein the web-shaped substrate (3) and the web-shaped nonwoven material (4) are interconnected on their mutually facing surfaces (3a, 4a), which form a connecting surface, by a plurality of discrete, distributed connecting points, the connecting points consisting of particles (7) containing a third thermoplastic polymer, the particles (7) adhering essentially only to the mutually facing surfaces (3a, 4a) of the substrate (3) and the nonwoven material (4).

2. A composite material according to claim 1, wherein the discrete, distributed connection points are spaced apart from each other with empty spaces between them.

3. A composite material according to claim 1, wherein the particles (7) engage positively in cavities of the nonwoven material (4).

4. A composite material according to claim 1, wherein the third thermoplastic polymer is selected from polyethylene terephthalate (PET), polypropylene (PP), and polyethylene (PE).

5. A composite material according to claim 1, wherein the particles (7) containing the third thermoplastic polymer have an average particle size of less than or equal to 1000 μm.

6. A composite material according to claim 1, wherein that the particles (7) containing the third thermoplastic polymer have a particle size greater than or equal to 100 μm.

7. Composite material according to claim 1, wherein the particles (7) containing the third thermoplastic polymer have a particle size between 100 μm and 1000 μm, in a size distribution whose peak value is at least 300 μm.

8. A composite material according to claim 1, wherein the particles (7) have a basis weight of between 1 g and 20 g per m², and are arranged on the connecting surface.

9. A composite material according to claim 1, wherein only the substrate (3), but not the nonwoven material (4), is perforated.

10. A composite material according to claim 1, wherein the substrate (3) has at least one layer of a plastic tape fabric.

11. A composite material according to claim 10, wherein the plastic tape fabric has a coating, or is a laminated plastic film.

12. A composite material according to claim 1, wherein the substrate (3) is a single-or multi-layer plastic film, which optionally is printed.

13. A composite material according to claim 1, wherein the nonwoven material (4) is a spunbonded nonwoven or a carded nonwoven or a spunlace material or a meltblown material or a spunbond material or a composite material made from the aforementioned materials.

14. A composite material according to claim 1, wherein the first and/or second thermoplastic polymer is selected from: PET, PP, PE, or a co-or terpolymer containing two or three of the following monomers: ethylene, propylene, vinyl acetate, alkyl acrylate, maleic anhydride, alpha-olefin.

15. A sack made of a composite material (2) according to claim 1, wherein, which is a tube piece made of a tubular composite material (2) or made of a flat composite material (2) formed into a tube (15), with a bottom being formed on at least one end of the tube piece.

16. A composite material according to claim 1, wherein the third thermoplastic polymer is a co polymer or terpolymer containing two or, respectively, three of the following monomers: ethylene, propylene, vinyl acetate, alkyl acrylate, maleic anhydride, or alpha olefin.

17. A composite material according to claim 8, wherein the particles (7) have a basis weight of between 3 g and 5 g per m².

18. A composite material according to claim 10, wherein the plastic tape fabric is made of PP, high-density polyethylene (HDPE), or PET.

19. A composite material according to claim 11, wherein the plastic tape fabric has a coating that is printed.

20. A composite material according to claim 12, wherein the single-or multi-layer plastic film is made of PP, linear low-density polyethylene (LLDPE), low-density polyethylene (LDPE), HDPE, or PET.
